(19) United States
(12) Patent Application Publication
(10) Pub. No.: US 2006/0152660 A1
(43) Pub. Date: Jul. 13, 2006

(54) Liquid crystal display apparatus

(75) Inventors: Shinichiro Tanaka, Tottori-shi (JP); Osamu Kobayashi, Tottori-shi (JP); Satoshi Morita, Tottori-shi (JP); Takao Yamauchi, Tottori-shi (JP); Takeshi Suzaki, Tottori-shi (JP); Sayaka Hiura, Tottori-shi (JP)

Correspondence Address: KATTEN MUCHIN ROSENMAN LLP, 525 WEST MONROE STREET, CHICAGO, IL, 60661-3693, US

(73) Assignees: Sanyo Electric Co., Ltd., Osaka (JP); Tottori Sanyo Electric Co., Ltd., Tottori (JP)

(21) Appl. No.: 10/562,070

(22) PCT Filed: Jun. 28, 2004
(86) PCT No.: PCT/JP04/09103

§ 371 Date: Dec. 22, 2005

(30) Foreign Application Priority Data
Jun. 30, 2003 (JP) 2003-187923
Jul. 11, 2003 (JP) 2003-273530
Jul. 31, 2003 (JP) 2003-283622

(51) Int. Cl. G02F 1/1343; G02F 1/1337

(52) U.S. Cl. 349/139; 349/129

(57) ABSTRACT

A liquid crystal display apparatus comprising a first substrate with pixel electrodes formed in regions surrounded by a plurality of scanning lines and signal lines, a second substrate on which a transparent electrode is formed, orientation controlling means formed at least on either the first substrate or the second substrate, alignment films deposited on both substrates to which vertical treatment is applied, and a liquid crystal layer having negative dielectric anisotropy, which is sandwiched between both substrates, wherein liquid crystal molecules are vertically aligned when no electric field is applied to the liquid crystal layer, and tilt to be aligned in directions controlled by the orientation controlling means when electric field is applied to the liquid crystal layer, whereby the orientation controlling means is positioned to be approximately linearly symmetrical by using a scanning line and a signal line as boundaries such that the position of the orientation controlling means in relation to pixels adjacent to each other along the scanning line differs from its position in relation to pixels adjacent to each other along the signal line.

### TECHNICAL FIELD

The present invention relates to a liquid crystal display apparatus having a wide viewing angle where a plurality of domains are provided in one pixel.

### BACKGROUND ART

Liquid crystal display devices are generally slim in size and lightweight, consume low power and are used for a wide range of products such as mobile terminals and large-sized television sets. The twisted nematic (TN) type of liquid crystal display apparatuses are often used as liquid crystal display apparatuses as they can maintain their levels of high performance and quality.

However, the TN type liquid crystal display apparatuses or the like have exhibited problems such as large dependency on viewing angle and the like. Therefore, the vertically aligned (VA) type of liquid crystal display apparatuses equipped with a wider viewing angle have been suggested. In the case of the VA type of liquid crystal display apparatuses, liquid crystal having negative dielectric anisotropy is filled between a pair of glass substrates, while pixel electrodes are arranged on one glass substrate, and common electrodes are arranged on the other glass substrate. Vertically oriented films are deposited on both glass substrates, and a pair of polarizing plates is arranged outside the two glass substrates such that their respective transparent axes become orthogonal to each other. When no electric field occurs between the two types of electrodes, the liquid crystal molecules are controlled by the vertically oriented films and become vertically aligned, and the transmitted polarized linear light that has passed through one polarizing plate passes through a liquid crystal layer and is blocked by the other polarizing plate. Further, the liquid crystal molecules between the glass substrates tilt in the vertical direction of the electric field and are horizontally aligned when electric field occurs between both electrodes, so that the transmitted polarized linear light that has passed through one polarizing plate becomes birefringent into transmitted polarized elliptical light when passing through the liquid crystal layer and then passes through the other polarizing plate.

To further improve the viewing angle of the VA type of liquid crystal display apparatus, the multi-domain vertically aligned (MVA) type has been suggested, where protrusions and grooves are provided in pixels to form a plurality of domains in one pixel. This is described Japanese Patent Publication No. 2947350 (Patent 1) and Japanese Laid-Open Patent Publication No. 2001-83517 (Patent 2), for example.

The pixel constitution of the conventional MVA type of liquid crystal display apparatus is shown in FIG. 10, where a pair of glass substrates is arranged to face each other in the parallel direction, and pixel electrodes 100, scanning lines 101, signal lines 102 and thin film transistors (TFTs) 103 are formed on one glass substrate, while color filters, common electrodes, and protrusions 105 are formed on the other glass substrate. Note that the color filters and the common electrodes are not shown. A plurality of the scanning lines 101 and the signal lines 102 are wired on the glass substrate in a matrix state, and the TFTs 103 and pixel electrodes 100 are arranged on the intersecting portions of the lines and in areas surrounded by the scanning lines 101 and the signal lines 102, respectively. Gate electrodes, source electrodes and drain electrodes of the TFTs 103 are connected to the scanning lines 101, the signal lines 102 and the pixel electrodes 100 respectively. Reference numeral 104 denotes a slit formed on the pixel electrode 100, the plurality of protrusions 105 being formed in a zigzag state when viewed from the normal direction of the glass substrate, the slits 104 being positioned between the plurality of protrusions 105, and are formed to lie approximately parallel with adjacent protrusions 105. Liquid crystal molecules tilt to a 90° angle in relation to the protrusion 105 and the slits 104, and tilt in opposite directions by using the protrusion 105 and the slit 104 as a boundary. A pair of polarizing plates of crossed nicols is arranged outside the pair of glass substrates, and an angle formed by the transparent axes of the polarizing plates and the direction of protrusions 105 is set to 45° in order to make the angle formed by the tilted liquid crystal molecules and the transparent axes of the polarizing plates become 45° when viewed from the normal direction of the polarizing plates. When the angle formed by the tilted liquid crystal molecules and the transparent axes of the polarizing plates becomes 45°, transmitted light can be obtained from the polarizing plates most efficiently.

### DISCLOSURE OF THE INVENTION

### PROBLEMS TO BE SOLVED BY THE INVENTION

Description will hereafter be made for the orientation directions of liquid crystal molecules in the conventional MVA type of liquid crystal display apparatus. Here, the orientation directions of liquid crystal molecules in one pixel is divided into four, being regions A to D of FIG. 10. It is assumed that liquid crystal molecules normally tilt from a slit 104 toward the adjacent protrusions 105. Region A is the area where liquid crystal molecules tilt obliquely to the upper left direction, region B is the region where liquid crystal molecules tilt obliquely to the lower right direction, region C is the region where liquid crystal molecules tilt obliquely to the lower left direction, and region D is the region where liquid crystal molecules tilt obliquely to the upper right direction.

Conventionally, the shape of the slits 104 and the protrusions 105 arranged in all pixels is uniform, and the ratio of regions A to D is the same for all pixels. Further, although ideally the areas pertaining regions A to D should become completely the same for all pixels, such areas actually differ due to the presence of the TFT 103, or an error in manufacturing the apparatus, or the like. Therefore, the amount of transmission coming from different directions differs for each pixel. Also, because the pixels are adjacent to each other, the quality of display is affected, such that dependency on viewing angle occurs and an emission line is recognized.

Consequently, the present invention seeks to address the above-described problems by improving the display quality of the liquid crystal display apparatus.

### MEANS FOR SOLVING THE PROBLEMS

To achieve the above-mentioned objective, the present invention is a liquid crystal display apparatus having: a first substrate that has pixel electrodes formed in regions surrounded by a plurality of scanning lines and signal lines; a second substrate on which a transparent electrode is formed; orientation controlling means that are formed at least on one of the first substrate and the second substrate; alignment films deposited on both the substrates, to which vertical alignment treatment is applied; and a liquid crystal layer having negative dielectric anisotropy, which is sandwiched between both the substrates, where liquid crystal molecules are vertically aligned when no electric field is applied to the liquid crystal layer, and liquid crystal molecules tilt to be aligned in directions controlled by the orientation controlling means when electric field is applied to the liquid crystal layer, in which the arrangement of the orientation controlling means are formed to be approximately symmetric with respect to a line by using the scanning line and the signal line as a boundary such that the arrangement of the orientation controlling means becomes different in pixels adjacent to each other along the scanning line or pixels adjacent to each other along the signal line.

In this manner, dependency on the viewing angle is reduced and the occurrence of an emission line is suppressed because the directional control characteristics in pixels horizontally and vertically adjacent to each other differ.

In this case, it is desirable that the orientation controlling means comprise belt-shaped protrusions that are formed on either one of the two substrates and slits corresponding to the protrusions that are formed on the other substrate in which no protrusions are formed. Further, it is desirable that the slits are formed on the pixel electrodes, while the belt-shaped protrusions are formed on the second substrate, the first polarizing plate being arranged outside the first substrate, and the second polarizing plate having a transparent axis which is orthogonal to the transparent axis of the first polarizing plate is arranged outside the second substrate.

Further, it is desirable that a sealing material that substantially adheres the entire periphery of the first substrate and the second substrate be provided except for a liquid crystal filling port, as well as a line parallel to the side on which the liquid crystal filling port has been provided be used as a line of symmetry, and the protrusions of two adjacent two pixels are formed to lie approximately linearly symmetrical.

Further, in order to improve the viewing angle of two directions or four directions in one pixel, it is desirable that directions controlled by the slits and the protrusions when electric field is applied to the liquid crystal layer consist of two or four directions.

Furthermore, another aspect of the present invention provides for a liquid crystal display apparatus having a first substrate on which pixel electrodes are arranged in a matrix state, a second substrate on which a transparent electrode is formed, orientation controlling means that are formed either on the first substrate or the second substrate, alignment films deposited on both substrates, to which vertical alignment treatment is applied, and a liquid crystal layer having negative dielectric anisotropy, which is sandwiched between the two substrates, where liquid crystal molecules are vertically aligned when no electric field is applied to the liquid crystal layer, and tilt to be aligned in directions controlled by the orientation controlling means when electric field is applied to the liquid crystal layer, where the arrangement of the orientation controlling means in two types of pixels used as unit pixels is linearly symmetrical and approximately the same number of the two types of pixels are arrayed irregularly.

In this manner, reliance on the viewing angle is reduced and the occurrence of an emission line is suppressed because the directional control characteristics in pixels horizontally and vertically adjacent to each other differ.

In this case, it is preferable that the orientation controlling means comprise belt-shaped protrusions that are formed on either the first substrate and the second substrate, and slits corresponding to the protrusions are formed on the other substrate in which no protrusions are formed. Further, it is preferable that the slits are formed on the pixel electrodes, while the belt-shaped protrusions are formed on the second substrate corresponding to the slits, the first polarizing plate be arranged outside the first substrate, while the second polarizing plate having the transparent axis which is orthogonal to the transparent axis of the first polarizing plate is arranged outside the second substrate.

Further, it is preferable that the protrusions in the unit pixel comprise one or more L-shaped protrusions and one or more linear protrusions lying parallel with the L-shaped protrusions, and the slits consist of one or more L-shaped slits lying parallel with the L-shaped protrusions and one or more linear slits lying parallel with the linear protrusions. Alternatively, it is preferable that the protrusions and the slits in the unit pixel be linear in form lying parallel with each other, and arranged so as to create an angle of approximately 45° in relation to the transparent axes of the first polarizing plate and the second polarizing plate.

### BRIEF DESCRIPTION OF THE DRAWINGS

FIG. 1 is a plane view of a pixel section in the liquid crystal display apparatus of Example 1 of the present invention.

FIG. 2 is a cross-sectional view taken along X-X line of FIG. 1.

FIG. 3 is a plane view of a pixel section of a liquid crystal display apparatus illustrating the filling route of a liquid crystal material of the liquid crystal display apparatus of Example 1 according to the present invention.

FIG. 4 is a plane view of a pixel section in the liquid crystal display apparatus of Example 2 of the present invention.

FIG. 5 is a plane view of a pixel section of a liquid crystal display apparatus illustrating the filling route of a liquid crystal material of Example 2 according to the present invention.

FIG. 6 is a plane view of a pixel section in the liquid crystal display apparatus of Example 3 of the present invention.

FIG. 7 is a plane view showing an example of the pixel array of Example 3 of the present invention.

FIG. 8 is a plane view of a pixel section in the liquid crystal display apparatus of Example 4 of the present invention.

FIG. 9 is a plane view showing an example of the pixel array of Example 4 of the present invention.

FIG. 10 is a plane view of a pixel section of a conventional MVA type of liquid crystal display apparatus.

### BEST MODE FOR CARRYING OUT THE INVENTION

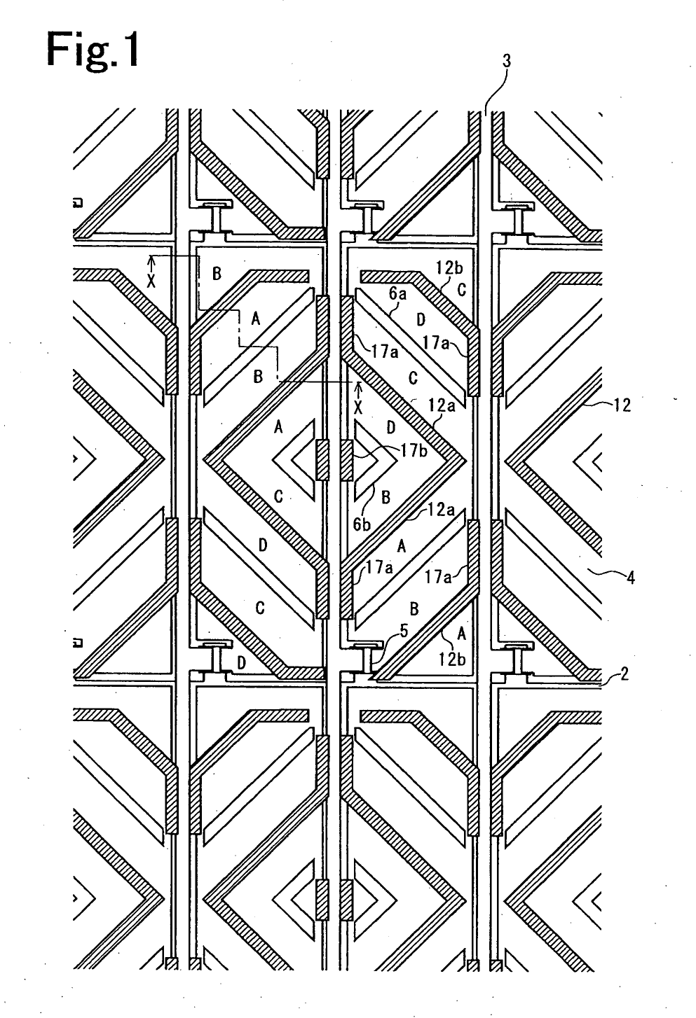

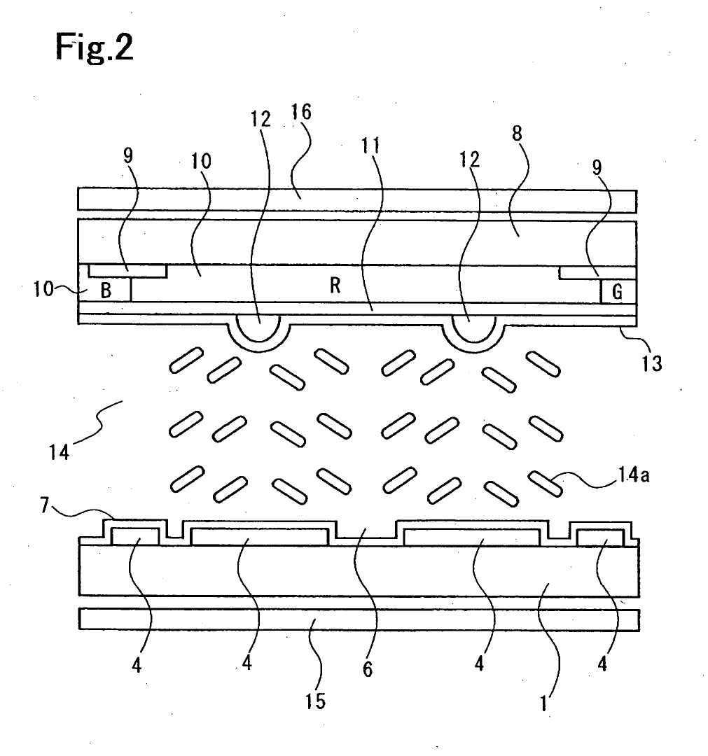

Description will be made hereafter of the embodiments of the present invention. FIG. 1 is a plane view of a pixel section in the liquid crystal display apparatus of Example 1 of the present invention, while FIG. 2 is a cross-sectional view taken along X-X line of FIG. 1.

### EXAMPLE 1

Reference numeral 1 denotes a transparent first substrate such as a glass substrate, to which scanning lines 2 and signal lines 3 are wired in a matrix state. A region surrounded by the scanning lines 2 and the signal lines 3 corresponds to one pixel, and a pixel electrode 4 is arranged in the region, while a switching element TFT 5 connecting to the pixel electrode 4 is formed at the portion where the scanning line 2 and the signal line 3 intersect. A part of the pixel electrode 4 overlaps an adjacent scanning line 2 via an insulating film, and this portion works as a retention capacitance. A plurality of slits 6 serving as the orientation controlling means (described later) is formed on the pixel electrode 4. Reference numeral 7 denotes an alignment film covering the pixel electrode 4 and to which vertical alignment treatment is applied. Note that an insulating film that exists under the pixel electrode 4 is not shown in FIG. 2.

Reference numeral 8 denotes a transparent second substrate such as a glass substrate, upon which a black matrix 9 is formed in order to sectionalize each pixel, and a color filter 10 is deposited corresponding to each pixel. The color filter 10, which may comprise any one color of red (R), green (G) and blue (B) is arranged corresponding to each pixel. A transparent electrode 11 such as ITO (Indium Tin Oxide) is deposited on the color filter 10, for example, and protrusions 12 functioning as orientation controlling means of a predetermined pattern are formed on the transparent electrode 11, and an oriented film 13 to which vertical alignment treatment has been applied covers the transparent electrode 11 and the protrusions 12.

A liquid crystal layer 14 having negative dielectric anisotropy is laid between the two substrates 1, 8. Then, liquid crystal molecules 14a are controlled by the alignment films 7, 13 and vertically aligned when no electric field occurs between the pixel electrode 4 and the transparent electrode 11, and tilt horizontally when electric field occurs between the pixel electrode 4 and the transparent electrode 11. At this point, the liquid crystal molecules 14a are controlled by the slits 6 and the protrusions 12 to tilt in a predetermined direction, and thus a plurality of domains can be formed in one pixel. Note that FIG. 2 schematically shows the state where electric field has occurred between the pixel electrode 4 and the transparent electrode 11.

The first polarizing plate 15 and the second polarizing plate 16 are arranged outside the first substrate 1 and outside the second substrate 8 respectively, and the transparent axes of the first polarizing plate 15 and the second polarizing plate 16 are set so as to be orthogonal to each other. When the transparent axes of the polarizing plates 15, 16 and the tilting direction of the liquid crystal molecules 14a creates an angle of approximately 45° when observed from the normal direction of the second substrate 8, transmitted light can pass through the second polarizing plate 16 most efficiently. Then, if the tilting direction of the liquid crystal molecules 14a is such as to create an angle of approximately 90° with respect to the protrusions 12 and the slits 6, the polarizing plates 15, 16 are arranged in such manner that the direction in which the slits 6 and the protrusions 12 extend in a pixel and the transparent axis of the second polarizing plate 16 form an angle of approximately 45°. In the liquid crystal display apparatus of Example 1, settings are made to allow the transparent axis of the first polarizing plate 15 to coincide with the extending direction of the scanning lines 2 and to allow the transparent axis of the second polarizing plate 16 to coincide with the extending direction of the signal lines 3.

Then, since the liquid crystal molecules 14a are vertically aligned when no electric field occurs between the pixel electrode 4 and the transparent electrode 11, linearly polarized transmitted light that has passed though the first polarizing plate 15 passes through the liquid crystal layer 14 directly as linearly polarized light, and is blocked by the second polarizing plate 16, yielding black display. Further, since the liquid crystal molecules 14a tilt horizontally when a predetermined voltage is applied to the pixel electrode 4 and electric field occurs between the pixel electrode 4 and the transparent electrode 11, the linearly polarized light having passed the first polarizing plate 15 becomes elliptically polarized light in the liquid crystal layer 14, and passes through the second polarizing plate 14, yielding white display.

When the cell gap (the gap between the oriented films 7, 13 on both substrates 1, 8) is made narrower, light leakage during black display is reduced and contrast improves to make the viewing angle wider. Although the transmission factor during white display is generally reduced when the cell gap is narrowed, in the present invention the cell gap can be made narrow without adversely affecting contrast because the transmission factor is improved by devising the shapes of the slits 6 and the protrusions 12 (both described later) or the like.

Next, the shapes of the slits 6 and the protrusions 12 will be described. The slits 6 are formed by removing a part of the pixel electrode 4 by means of a photolithographic method or the like, and the protrusions 12 are formed by allowing resist made of acrylic resin or the like, for example, to form a predetermined pattern using the photolithographic method. In this case, the height of the protrusions 12 is set to 1.2 μm. Meanwhile, the thickness of the liquid crystal layer 14 is set to 4 μm. It should be noted that the transmission factor improves when the protrusions 12 are formed by a positive material rather than a negative material. This is because the positive material makes the surface of the protrusions 12 smoother and improves the controlling force to cause the liquid crystal molecules 14a to tilt, and based on testing results, the transmission factor of the protrusions 12 made of positive material was enhanced by approximately 10% or more compared to the improvement of the transmission factor of the protrusions 12 made of negative material[(transmission factor(positive protrusion)/transmission factor(negative protrusion)≧1.10].

The protrusions 12 are formed in a zigzag state, and their straight portions are extended in the direction of a 45° angle in relation to the signal lines 3 when viewed from the normal direction of the second substrate 8. At the approximately middle portion of one pixel, a protrusion 12a extending from the edge portion of one pixel electrode 4 is bent to an L-shape and extended again to the edge portion of the pixel electrode. Two protrusions 12b extending from the other edge portion of the pixel electrode 4 are arranged to lie parallel with the straight portion of the protrusion 12a that is bent at right angles, and are positioned near the corner portions of the pixel electrode 4. At the portions where the protrusion 12 and the pixel electrode 4 intersect, auxiliary protrusions 17a that extend along the edge portion of the pixel electrode 4 are formed while branching from the protrusion 12, and they act to reduce any effect caused by the incidence of electric field to the liquid crystal molecules 14a from the edge portion of the pixel electrode 4 and adjacent pixels.

The slits 6 are severally formed so as to reside in the middle of the protrusions 12, and three slits 6 are formed in each pixel electrode 4 in this embodiment. Slits 6a are severally formed to lie parallel with the protrusions 12a and 12b, and a slit 6b is formed to lie parallel with the protrusion 12a between the protrusion 12a and the edge portion of the pixel electrode 4. Further, since the tilting direction of the liquid crystal molecules 14a is not controlled in the vicinity of the slits 6, uneven display occurs in such areas if the width of the slits 6 is enlarged to make the slit portions broad. Therefore, it is desirable to specify a certain width for the slits 6 to avoid the occurrence of uneven display.

Reference numeral 17b denotes an auxiliary protrusion provided along the edge portion of the pixel electrode 4 that is in close proximity to the slit 6b, and serves to reduce any effect caused by the incidence of electric field to the liquid crystal molecules 14a from the edge portion of the pixel electrode 4 and adjacent pixels. Particularly, the area surrounding the slit 6b and the pixel electrode 4 is narrow and is much easily affected by the slit 6b and the edge portion, so that the auxiliary protrusion 17b works effectively to reduce the uneven display caused by the region.

Next, description will be made for the orientation directions of the liquid crystal molecules 14a. The orientation directions of liquid crystal molecules 14a in one pixel are divided into the specified regions A to D in FIG. 1. It is assumed that the liquid crystal molecules 14a tilt from the slit 6 toward the adjacent protrusion 12. Region A is the area where liquid crystal molecules tilt obliquely to the upper left, region B is the area where liquid crystal molecules tilt obliquely to the lower right, while region C is the area where liquid crystal molecules tilt obliquely to the lower left, and region D is the area where liquid crystal molecules tilt obliquely to the upper right.

The areas of the regions A to D in one pixel differ from each other and this is because of the presence of the TFT 5 or the like. However, in pixels horizontally and vertically positioned adjacent to each other, the slits 6 and the protrusions 12 are linearly symmetrically arranged. Specifically, by using the signal line 3 as a boundary, the slits 6 and the protrusions 12 of adjacent pixels along the scanning line 2 are linearly symmetrical, while the slits 6 and the protrusions 12 of adjacent pixels along the signal line 3 are linearly symmetrical by using the scanning line 2 as a boundary.

Therefore, since pixels having the same characteristics are not horizontally and vertically adjacent to each other even if the transmission amount coming from one direction and the transmission amount coming from another direction differ from each other in one pixel, so that dependency on the viewing angle is reduced and the occurrence of an emission line is suppressed.

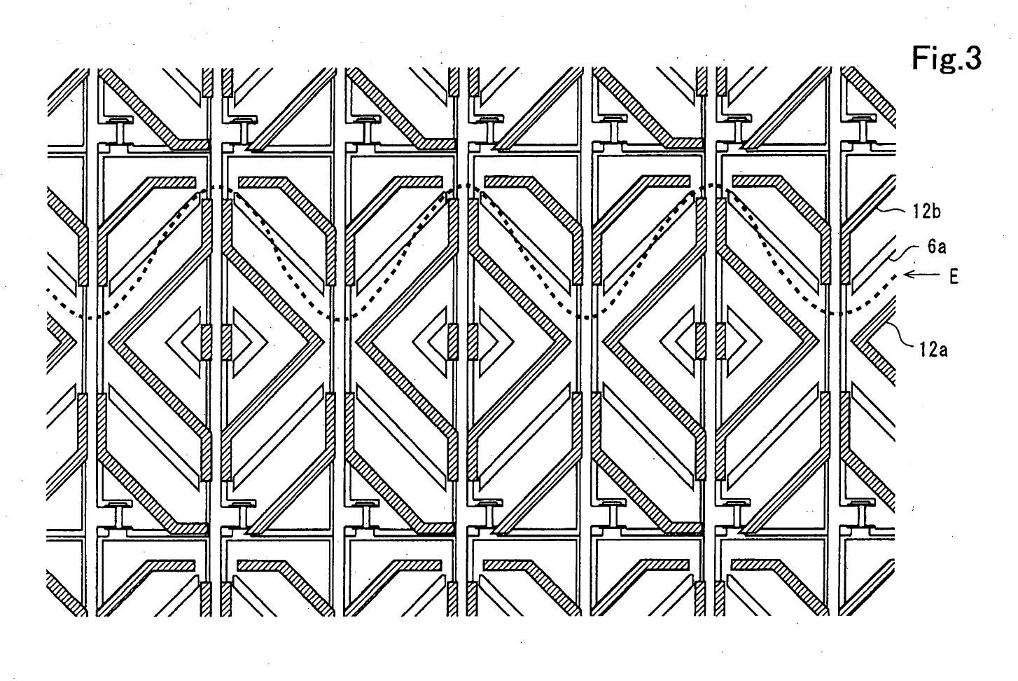

Next, description will be made for the liquid crystal filling process. The filling process can be executed by means of a filling device pertaining to a vacuum method similar to the conventional method. FIG. 3 is a plane view of a pixel section of a liquid crystal display apparatus illustrating the filling route of the liquid crystal material of this Example 1. Arrow E in the drawing refers to the filling direction of the liquid crystal material, and the broken line shows an example of a route where the liquid crystal material flows most smoothly when liquid crystal is being filled. Note that a filling port (not shown) should be provided on the short side of the screen in a manner similar to the conventional method.

In the case of filling liquid crystal material by means of a filling device pertaining to the vacuum method, an empty cell and a container containing the liquid crystal material are set in an airtight device, after which the airtight device is entirely evacuated, and the filling port of the empty cell is soaked in the liquid crystal material after the inner portion of the empty cell has become a vacuum, and then nitrogen gas or the like is allowed to flow into the entirety of the airtight device. Thereafter, when the airtight device is returned to atmospheric pressure, the liquid crystal material is pushed into the empty cell which is now a vacuum and the material is filled into the empty cell due to capillary phenomenon. After the filling process is completed, an adhesive agent or the like is coated on the filling port of the cell, the adhesive agent on the filling port being cured by heat or ultraviolet irradiation to plug up the filling port.

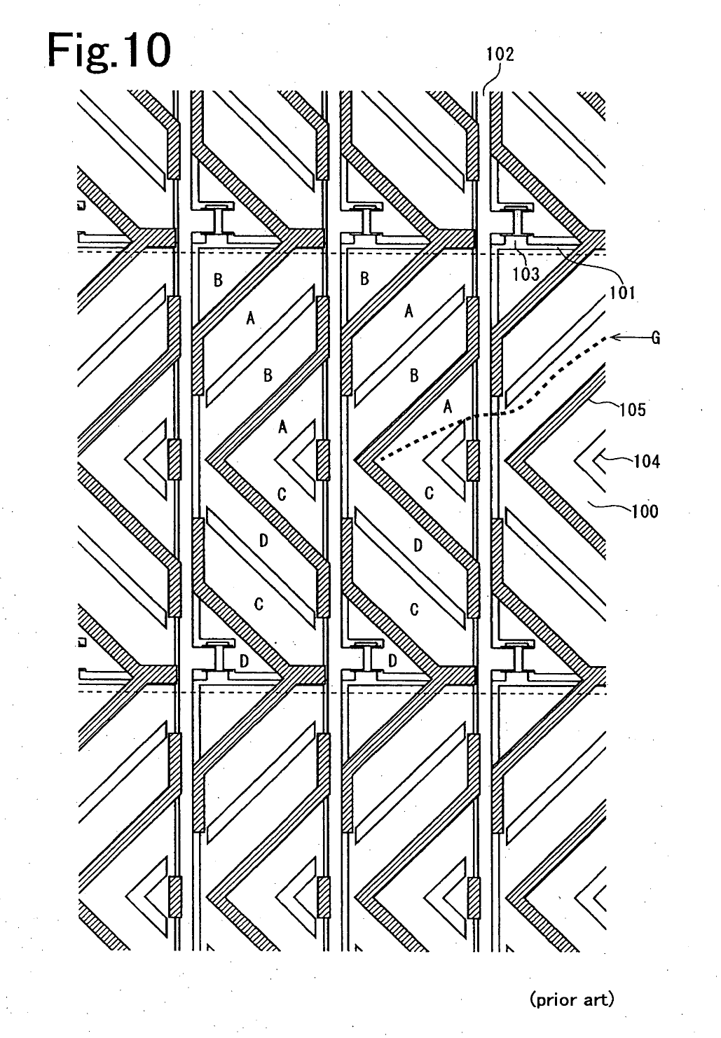

In the case of filling the cells of the conventional liquid crystal display apparatus (shown in FIG. 10) with liquid crystal material, the filling port is provided on the short side of the screen and the liquid crystal material is filled in the direction of arrow G depending on certain conditions, such as the size of the airtight device. In FIG. 10, the broken line refers to an example of a route where the liquid crystal material flows during the filling process. The liquid crystal material which is filled in the direction of arrow G passes between the protrusions 105, and hits an area where the protrusion 105 of an adjacent pixel is in dogleg shape such that the filling flow is held back. Then, even if the flow goes beyond the dogleg-shaped area, the flow slows down again at a similar region of the adjacent pixel. Accordingly, the period during which the liquid crystal material reaches the side opposite to the side where the liquid crystal filling port is provided is delayed. Thus, enormous time is required in the liquid crystal filling process, which is approximately 13 to 15 hours in the case of the above-described cell.

On the contrary, in the liquid crystal display apparatus of Example 1 shown in FIG. 3, the liquid crystal material filled in the apparatus can flow between the protrusions 12a and the protrusions 12b along the slits 6a and travel to the side opposite to the liquid crystal port without crossing the protrusions 12 and the auxiliary protrusions 17 and without traveling in a direction parallel to the side on which the liquid crystal filling port is provided, and thus the flow does not slow down when it hits the dogleg-shaped area of the protrusion 105 as in the conventional case. Note that liquid crystal gradually flows into a square-shaped region surrounded by the protrusions 12a from the area between the protrusion 12a and the pixel electrode 4 and the area between two auxiliary protrusions 17a. Based on experiment results, recorded liquid crystal filling time was 8 to 10 hours, revealing that the conventional period of 13 to 15 hours could be significantly shortened. It is believed that the entire filling time was shortened because the liquid crystal material can be filled into the areas surrounded by the protrusions 12, which considerably hamper the filling process, by securing a route where the liquid crystal material smoothly flows without crossing the protrusions 12 and the auxiliary protrusions 17.

Meanwhile, in this Example 1, description has been made for the liquid crystal display apparatus having four orientation directions in one pixel. However, the number of orientation directions of one pixel of the said apparatus is not limited to four, as it may be in multiples of three directions or two directions. When the shape of one pixel, manufacturing technology and the like are entirely taken into consideration, two to four orientation directions of one pixel would be sufficient in improving the viewing angle.

Further, in this Example 1, the slits 6 and the protrusions 12 as orientation controlling means are positioned to be linearly symmetrical in pixels horizontally and vertically adjacent to each other. However, the slits 6 and the protrusions 12 need not be exactly linearly symmetrical, as long as they are approximately linearly symmetrical, even as their end portions are slightly different in shape. Particularly, depending on the presence or absence of the TFT 5, it may be necessary to change the shape of the auxiliary protrusion 17 located at the end portion of the pixel electrode 4, and it does not matter that there be such slight difference in shape.

According to this Example 1, pixels that have the same characteristics are not horizontally and vertically adjacent to each other even if the transmission amount coming from one direction and the transmission amount coming from another direction differ in one pixel. Therefore, dependency on the viewing angle is reduced, because the display condition varies depending on the direction from which viewing is made, and the occurrence of an emission line, whether vertical or horizontal in orientation, is suppressed, and thus it is possible to provide a liquid crystal display apparatus having high display quality.

### EXAMPLE 2

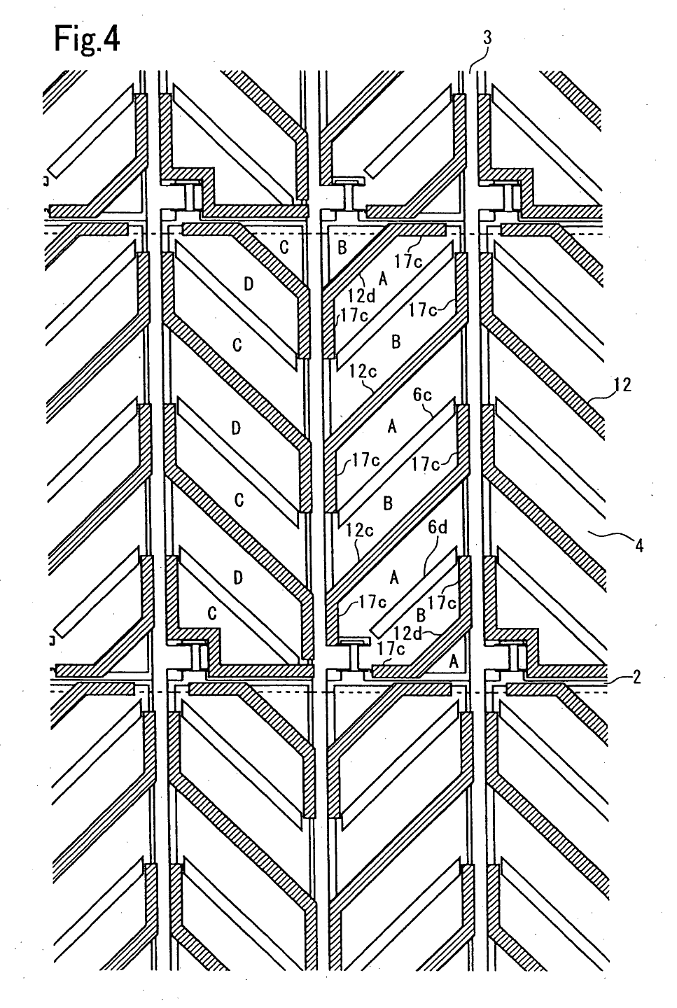

FIG. 4 is a plane view of a pixel section of the liquid crystal display apparatus of Example 2 of the present invention. The layer constitution of the liquid crystal display apparatus of Example 2 is the same as that of Example 1, and only the shapes of protrusions 12, auxiliary protrusions 17 and slits 6 are different.

Protrusions 12c, 12d are extended in the direction of a 45° angle in relation to the signal lines 3 when viewed from the normal direction of the second substrate 8. In one pixel, four protrusions 12c, 12d are arranged to lie parallel between the edge portions of the pixel electrode 4. At the portions where the protrusions 12c, 12d and the pixel electrode 4 intersect, auxiliary protrusions 17c that branch from the protrusions 12c, 12d to be extended along the edge portions of the pixel electrode 4 are formed, and as such, serve to reduce the adverse effect that may be caused by the electric field to the liquid crystal molecules 14a from the edge portion of pixel electrode 4 and adjacent pixels.

In addition, in the present embodiment, slits 6c, 6d are severally formed so as to reside in the middle of a plurality of protrusions 12, and three slits 6 are respectively formed in each pixel electrode 4. The slits 6c are formed between and parallel to the protrusions 12c, and the slits 6d are formed between and parallel to the protrusions 12c and 12d. Further, since the areas in the vicinity of the slits 6c, 6d do not control the tilting direction of the liquid crystal molecules 14a, such areas cause uneven display if the width of the slits 6c, 6d is enlarged to make the slit portions broader. Therefore, it is preferable to set a certain width for the slits 6c, 6d to avoid the occurrence of uneven display.

Next, description will be made for the orientation directions of the liquid crystal molecules 14a. In FIG. 4, the orientation directions of the liquid crystal molecules 14a in one pixel are mainly divided into regions A and B and regions C and B in the adjacent pixel linearly symmetrical thereto. It is assumed that the liquid crystal molecules 14a tilt from a slit 6 toward adjacent protrusions 12. In the second embodiment, two types of pixels having regions A and B and regions C and D in one pixel are severally arranged in horizontal and vertical directions to reduce dependency on the viewing angle or the like.

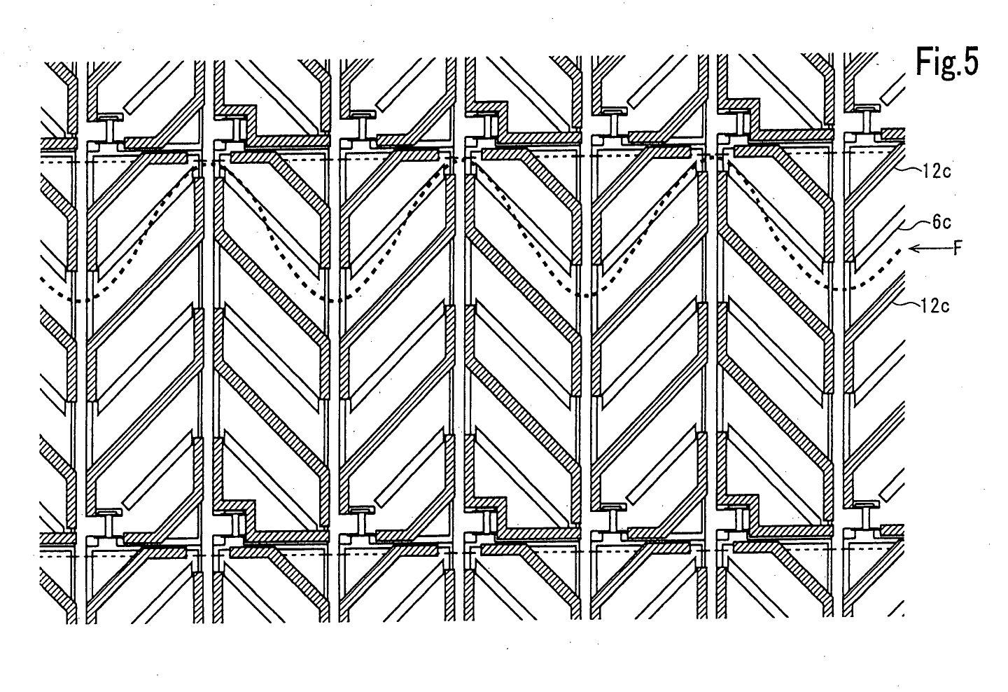

Next, description will be made for the liquid crystal filling process. The filling process can be executed by means of a filling device pertaining to a vacuum method similar to that of prior art. FIG. 5 is a plane view of a pixel section of a liquid crystal display apparatus illustrating the filling route of liquid crystal material of this Example 2. Arrow F in the drawing refers to the filling direction of the liquid crystal material, and the broken line refers to an example of a route where the liquid crystal material flows most smoothly when liquid crystal is being filled. Note that a filling port (not shown) should be provided on the short side of the screen in a manner similar to the conventional method.

The filled liquid crystal material can thus travel to the side opposite the liquid crystal filling port without being greatly affected by the protrusions 12 and the auxiliary protrusions 17, and the flow is also prevented from being held back when it hits the dogleg-shaped area of the protrusion 105 as in the case of prior art. Experiment results indicate that liquid crystal filling time is 8 to 10 hours, revealing that the conventional period of 13 to 15 hours could be significantly shortened.

Meanwhile, in the embodiments of the present invention, the slits and the protrusions are linearly symmetrical in pixels horizontally and vertically adjacent to each other. However, they need not be exactly linearly symmetrical, as long as they are approximately linearly symmetrical, even as their end portions slightly differ in shape. Particularly, depending on the presence or absence of the TFT, it may be necessary to change the shape of the auxiliary protrusion 17 located at the end portion of the pixel electrode 4, and it does not matter that there be such slight difference in shape.

Further, in the case where the orientation directions in one pixel are set to four directions according to the shape of the slits and the protrusions illustrated in Example 1, an orientation defect could easily occur because the liquid crystal molecules are not in an ideal state of orientation at the bent portion of the protrusions 12a. However, in the case where the orientation directions in one pixel are set to two directions according to the shape of the slits and the protrusions illustrated in Example 2, the number of bent portions is smaller than that of Example 1 and the number of areas where the orientation defect easily occurs is also fewer, so that it is possible to secure more areas having an ideal state of orientation particularly when the size of pixels becomes smaller to yield higher definition.

### EXAMPLE 3

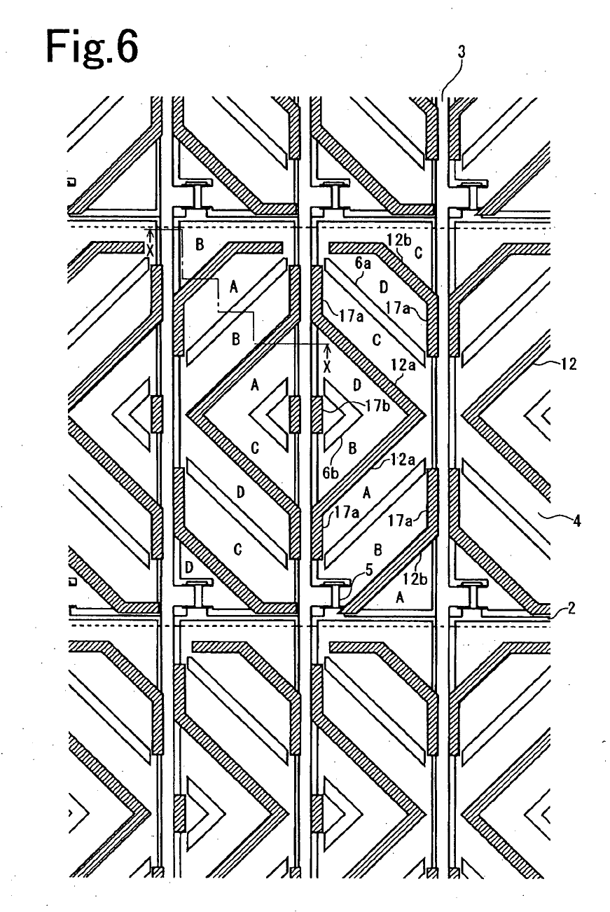

FIG. 6 is a plane view of a pixel section in a liquid crystal display apparatus of Example 3 of the present invention. The layer constitution of the liquid crystal display apparatus of Example 3 is likewise similar to that of Example 1, and only the shapes of protrusions 12, auxiliary protrusions 17 and slits 6 are different.

Since pixels of the same constitution are similarly arrayed in the direction as illustrated in the conventional apparatus of FIG. 10, orientation directions in large and small quantities occur in the entire screen, giving rise to dependency on the viewing angle.

On the other hand, although the area ratio among regions A to D in one pixel is not equal in the liquid crystal display apparatus of this Example 3, the area ratio among regions A to D becomes approximately equal in two pixels whose orientation directions are approximately linearly symmetrical, as shown in FIG. 6. In this case, the linearly symmetrical pixels are pixels that are formed when the protrusions and the slits are approximately superposed when any two pixels are quasi-bent at an imaginary line between them. In Example 3 shown in FIG. 6, the two adjacent pixels drawn at the center thereof refer to linearly symmetric pixels in relation to the using the signal line 3 as the center of reference. Meanwhile, the pixels need not be exactly linearly symmetrical, but may be approximately symmetrical as when the shape of the end portions of the slits 6 and the protrusions 12 are slightly different from each other. Particularly, depending on the presence or absence of the TFT, it may be necessary to change the shape of the auxiliary protrusion located at the end portion of the pixel electrode 4, and it does not matter that there be such slight difference in shape.

In addition, it is possible to cause the pixels to be arrayed by allowing two linearly symmetric pixels to be adjacent to each other. In other words, the pixels are regularly arrayed as sets of two pixels. However, according to this regular arrangement, when a regular image such as stripes and checkerboard pattern is created by using a pixel as a unit, there are cases where the image displayed comprises only pixels of one type out of the two-type constitution pixels, and it is probable that dependency on the viewing angle will arise as in the case of prior art.

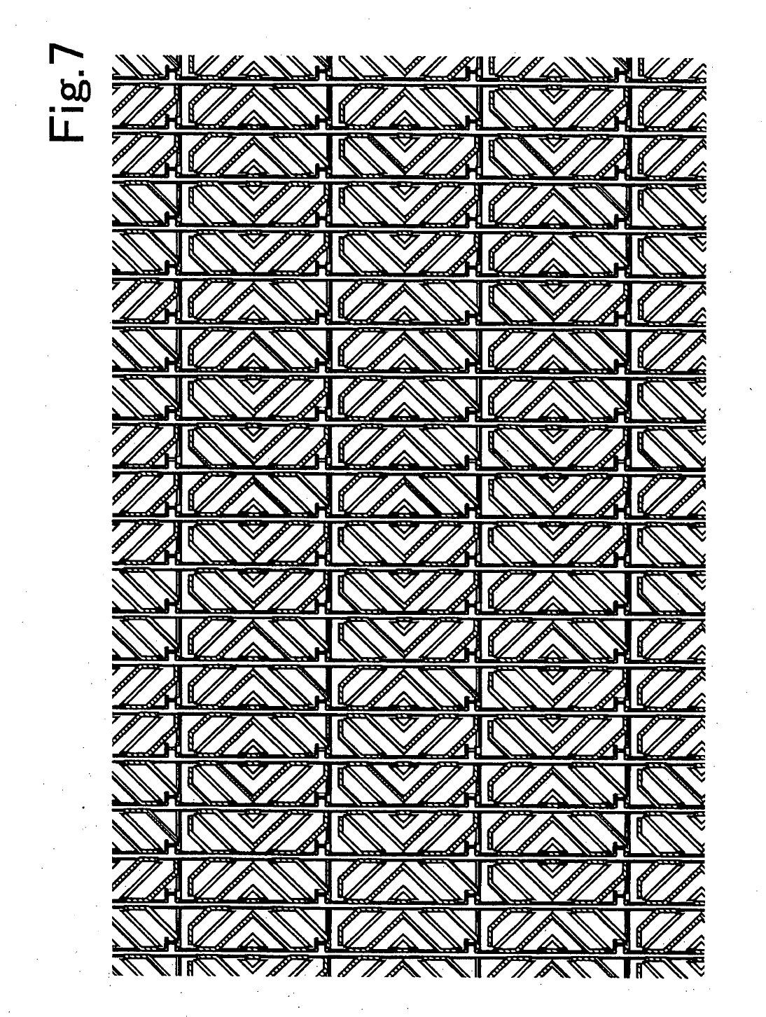

Consequently, this Example 3 uses two types of linearly symmetric pixels, and the same number of the pixels is irregularly arrayed. FIG. 7 is a plane view showing a sample of the pixel array of this Example 3. By using the same number of linearly symmetric pixels, the area ratio of each orientation direction becomes approximately equal on the entire screen. Further, by arranging the pixels to be irregularly arrayed, display is performed using the two types of pixels even when a regular image is displayed, so that dependency on the viewing angle is improved.

### EXAMPLE 4

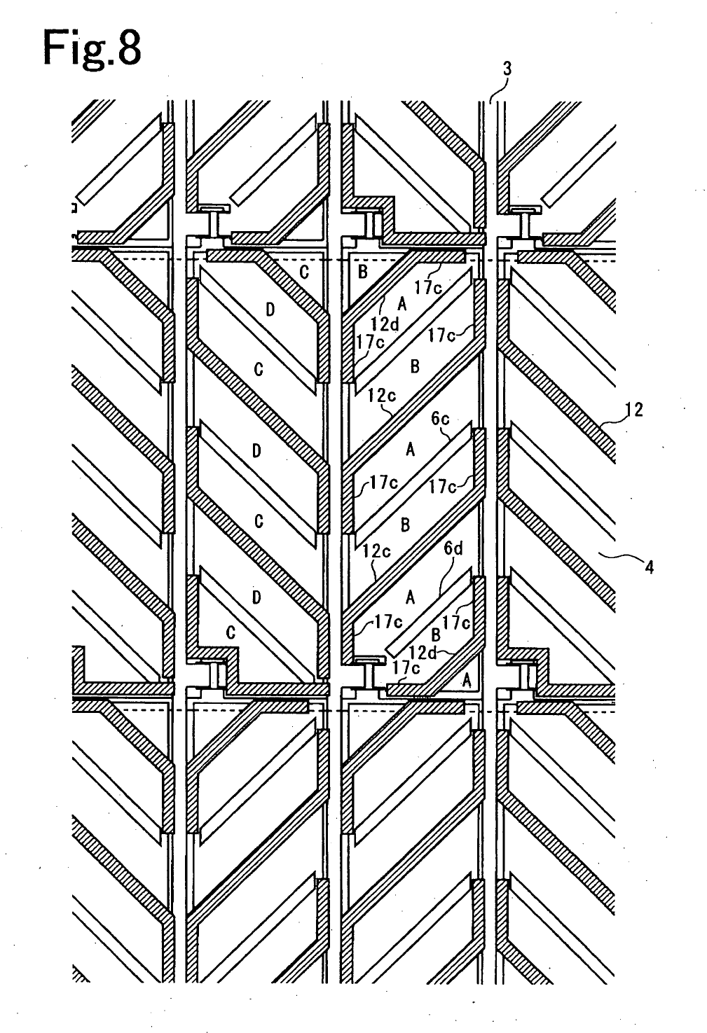

FIG. 8 is a plane view of a pixel section in the liquid crystal display apparatus of Example 4 of the present invention. The layer constitution of Example 4 is the same as that of Example 1 shown in FIG. 2, and only the shapes of protrusions 12, auxiliary protrusions 17 and slits 6 are different.

The protrusions 12c, 12d are extended in the direction of a 45° angle in relation to the signal lines 3 when viewed from the normal direction of the second substrate 8. In one pixel, the four protrusions 12c, 12d are arranged to lie parallel between the edge portions of the pixel electrode 4. At the portions where the protrusions 12c, 12d and the pixel electrode 4 intersect, the auxiliary protrusions 17c that branch from the protrusions 12c, 12d to be extended along the edge portions of the pixel electrode 4 are formed, and they reduce any effect caused by the incidence of electric field to the liquid crystal molecules 14a from the edge portion of the pixel electrode 4 and adjacent pixels.

Further, in the present embodiment, the slits 6c, 6d are severally formed so as to reside in the middle of a plurality of protrusions 12, and three slits 6 are respectively formed in each pixel electrode 4. The slits 6c are formed between and parallel to the protrusions 12c, and the slits 6d are formed between and parallel to the protrusion 12c and 12d. Further, since the areas in the vicinity of the slits 6c, 6d do not control the tilting direction of the liquid crystal molecules 14a, such areas cause uneven display if the width of the slits 6c, 6d is enlarged to make the slit portions broader. Therefore, it is preferable to set a certain width for the slits 6c, 6d to avoid the occurrence of uneven display.

Next, description will be made for the orientation directions of the liquid crystal molecules 14a. The liquid crystal display apparatus of FIG. 8 is made up of two types of pixels having different shapes of protrusions 12 and slits 6, and their protrusions 12 and slits 6 are linearly symmetrically arranged. In one pixel, the orientation directions of the liquid crystal molecules 14a mainly consist of regions A and B, and in the other pixel, the orientation directions of the liquid crystal molecules 14a mainly consist of regions C and D. Assuming that the liquid crystal molecules 14a tilt from a certain slit 6 toward an adjacent protrusion 12, the area ratio between region A and region B or the area ratio between region C and region D in one pixel is equal. Therefore, the area ratio among regions A to D is approximately equal when the two linearly symmetrical pixels symmetric are combined.

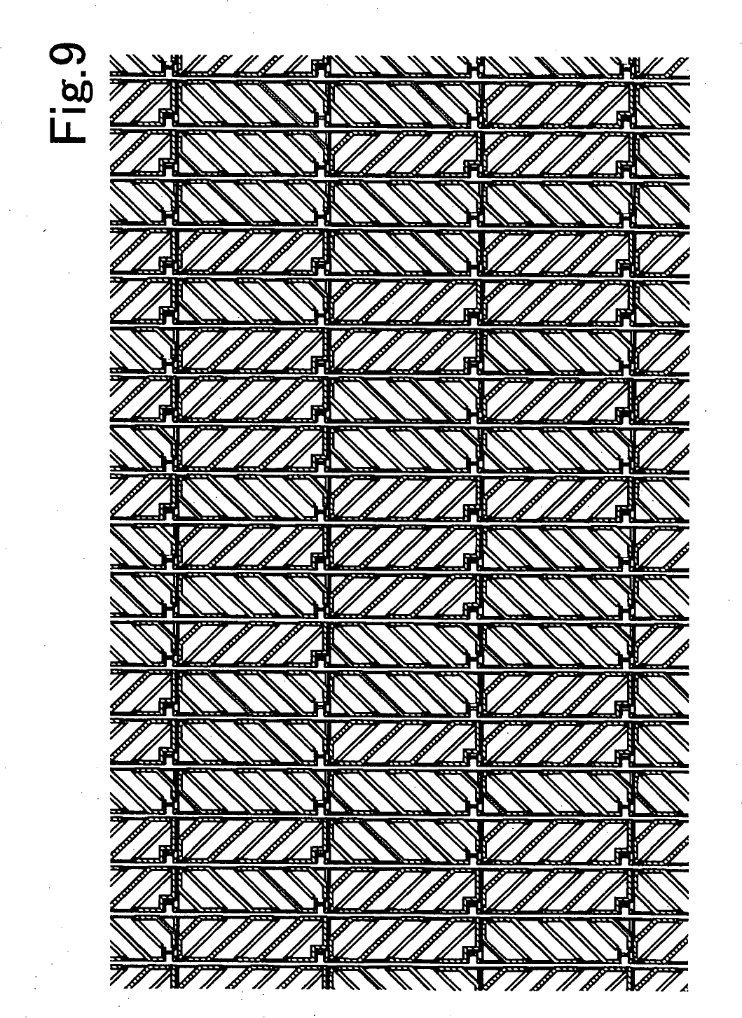

There are cases where regularly arraying the two pixels is not preferable in the liquid crystal display apparatus of this Example 4 for the same reason given with respect to Example 3. Therefore, two types of linearly symmetrical pixels are used and the same number of the pixels is arrayed irregularly in the liquid crystal display apparatus of this Example 4. FIG. 9 is a plane view showing a sample of the pixel array of this Example 4. By using the same number of linearly symmetric pixels, the area ratio of each orientation direction becomes approximately equal on the entire screen. Further, by arranging the pixels to be irregularly arrayed, display is performed using two types of pixels even when a regular image is displayed, so that dependency on the viewing angle is improved.

Meanwhile, in Examples 3 and 4, the slits are provided on the first substrate and the protrusions and the auxiliary protrusions are provided on the second substrate, but the arrangement of the protrusions, the auxiliary protrusions and the slits may be mixed in the two substrates, and only one of the protrusions or slits may be used as orientation controlling means. In forming only the protrusions or the slits, they can be provided on either substrate only or on both substrates.

As described above, the liquid crystal display apparatus of the present invention employs the MVA method, and can be preferably used for a liquid crystal display apparatus that requires a wide viewing angle such as a television set and a display.

1. A liquid crystal display apparatus, comprising:
a first substrate having pixel electrodes formed in regions surrounded by a plurality of scanning lines and signal lines;
a second substrate on which a transparent electrode is formed;
orientation controlling means that are formed at least on either the first substrate or the second substrate;
alignment films deposited on the said two substrates, to which vertical alignment treatment is applied; and
a liquid crystal layer having negative dielectric anisotropy, which is sandwiched between the two substrates, where liquid crystal molecules are vertically aligned when no electric field is applied to the said liquid crystal layer, and tilt to be aligned in directions controlled by the said orientation controlling means when electric field is applied to the said liquid crystal layer,
whereby the said orientation controlling means is positioned to be approximately symmetrical with respect to a line by using the said scanning line and the said signal line as a boundary such that the position of the orientation controlling means in relation to pixels adjacent to each other along the scanning line differs from its position in relation to pixels adjacent to each other along the signal line.

2. The liquid crystal display apparatus according to claim 1, wherein the orientation controlling means comprises belt-shaped protrusions that are formed at least on either the first substrate or the second substrate, and slits corresponding to the said protrusions are formed on the other substrate in which no protrusions are formed.

3. The liquid crystal display apparatus according to claim 2, wherein the said slits are formed on the said pixel electrodes, the said belt-shaped protrusions being formed on the said second substrate, where a first polarizing plate is arranged outside the first substrate, and a second polarizing plate having a transparent axis which is orthogonal to the transparent axis of the first polarizing plate is arranged outside the second substrate.

4. The liquid crystal display apparatus according to claim 2, wherein a sealing material that substantially adheres the entire periphery of the first substrate and the second substrate is provided except for a liquid crystal filling port, and the said protrusions of two adjacent pixels are formed to lie approximately linearly symmetrical by using either the said scanning line or the said signal line which is parallel to the side on which the said liquid crystal filling port has been provided as a boundary.

5. The liquid crystal display apparatus according to claim 1, wherein the directions controlled by the said slits and the said protrusions when electric field is applied to the said liquid crystal layer are any one of two directions or four directions.

6. A liquid crystal display apparatus, comprising:
a first substrate on which pixel electrodes are arranged in a matrix state;
a second substrate on which a transparent electrode is formed;
orientation controlling means that are formed either on the said first substrate or the said second substrate;
alignment films deposited on the said two substrates to which vertical alignment treatment is applied; and
a liquid crystal layer having negative dielectric anisotropy, which is sandwiched between the two substrates, where liquid crystal molecules are vertically aligned when no electric field is applied to the liquid crystal layer, and tilt to be aligned in directions controlled by the said orientation controlling means when electric field is applied to the liquid crystal layer,
where the arrangement of the orientation controlling means in two types of pixels used as unit pixels is linearly symmetrical and approximately the same number of the two types of pixels are irregularly arrayed.

7. The liquid crystal display apparatus according to claim 6, wherein the orientation controlling means comprise belt-shaped protrusions that are formed at least on either the first substrate or the second substrate, and slits corresponding to the said protrusions are formed on the other substrate in which no protrusions are formed.

8. The liquid crystal display apparatus according to claim 7, wherein the slits are formed on the said pixel electrodes, the belt-shaped protrusions being formed on the second substrate corresponding to the said slits, the said first polarizing plate being arranged outside the first substrate, and the second polarizing plate having a transparent axis which is orthogonal to the transparent axis of the first polarizing plate is arranged outside the second substrate.

9. The liquid crystal display apparatus according to claim 7, wherein the protrusions in a unit pixel comprise one or more L-shaped protrusions and one or more linear protrusions lying parallel with the L-shaped protrusions, and the slits consist of one or more of L-shaped slits lying parallel with the L-shaped protrusions and one or more linear slits lying parallel with the said linear protrusions.

10. The liquid crystal display apparatus according to claim 7, wherein the protrusions and the slits in a unit pixel be linear in form lying parallel with each other, and are arranged so as to create an angle of approximately 45° in relation to the transparent axes of the first polarizing plate and the second polarizing plate.
